(19) United States
(12) Patent Application Publication
(10) Pub. No.: US 2015/0304370 A1
(43) Pub. Date: Oct. 22, 2015

(54) CLOUD VOICE OVER INTERNET PROTOCOL COMMUNICATION SUBSTITUTE FOR CHANNEL RADIO BASED COMMUNICATION

(71) Applicant: EMPIRE TECHNOLOGY DEVELOPMENT LLC, Wilmington, DE (US)

(72) Inventor: Benjamin MAYTAL, Mevasseret-Zion (IL)

(21) Appl. No.: 14/441,622

(22) PCT Filed: Dec. 19, 2012
(86) PCT No.: PCT/US12/70630

§ 371 Date: May 8, 2015

(51) Int. Cl. H04L 29/06; H04L 12/18; H04W 4/02

(52) U.S. Cl. CPC H04L 65/403; H04W 4/02; H04L 12/185

(57) ABSTRACT

Technologies and implementations for facilitating channel-based communication via VOIP are generally disclosed. Example methods may include receiving a communication preference from the plurality Receive a Communication Preference from a Number of Mobile Devices of mobile devices, receiving a status identifier from the plurality of mobile devices and designating one or more of the plurality of mobile devices as belonging to a communication group based at least in part on the received communication preferences and the received Receive a Status Identifier from the Mobile Devices status identifiers.

### BACKGROUND

Unless otherwise indicated herein, the approaches described in this section are not prior art to the claims in this application and are not admitted to be prior art by inclusion in this section.

Cellular phone technology is increasing in popularity. However, despite the use of cellular phones to communicate, communication using unlicensed radio channels is still very popular.

In general, unlicensed radio channels may be used to communicate over both “short” and “long” distances. For example, drivers (e.g., truck, taxi, recreational) may use citizen band (CB) radio to communicate with each other over unlicensed radio frequencies. Such radio communication may be made between drivers even when the drivers do not know each other. Various types of information (e.g., road conditions, police speed traps, general conversations, or the like) may be communicated between the drivers using CB radios.

As another example, persons at a ski resort may use walk-talkies to communicate. Information (e.g., length of lift lines, condition of the ski runs, or the like) may be communicated between the persons using the walkie-talkies.

As an additional example, the IEEE 802.11 p standard (wireless access in vehicular environments “WAVE”) may be used to facilitate transmitting data between nearby vehicles or roadside infrastructure. This technology may be implemented in Intelligent Transportation Systems (ITS) applications and can be used to pre-warn other vehicles (i.e., drivers) on the road of potential problems (e.g., water on the roadway).

However, communication using unlicensed radio channels may be affected by a number of factors (e.g., unpredictable range, undesirable communication on a particular channel, or the like. Furthermore, a dedicated device, (e.g., CB radio, walkie-talkie, 802.11 p capable device, or the like) needs to be carried.

### SUMMARY

Detailed herein are various illustrative methods for facilitating channel-based communication via voice over Internet protocol (VOIP).

Example methods may include receiving a communication preference from the plurality of mobile devices, receiving a status identifier from the plurality of mobile devices and designating one or more of the plurality of mobile devices as belonging to a communication group based at least in part on the received communication preferences and the received status identifiers.

Some other example methods may include receiving a communication preference from a plurality of mobile devices, receiving a status identifier from the plurality of mobile devices, designating one or more of the plurality of mobile devices as belonging to a communication group based at least in part on the received communication preferences and the received status identifiers, and automatically bifurcating the communication group into a first communication group and a second communication group based at least in part on the received communication preferences and the received status identifiers.

Some alternative example methods may include at a mobile device, receiving a communication preference, providing the received communication preference and a status identifier to a communication server, and receiving a request to join a first VOIP conference call from the communication server, wherein the request to join the first VOIP conference call is based at least in part on the provided communication preference and the provided status identifier.

The present disclosure also describes various example machine-readable non-transitory medium having stored therein instructions that, when executed, operatively enable a communication module to receive a communication preference from a plurality of mobile devices, receive a status identifier from the plurality of mobile devices, and designate one or more of the plurality of mobile devices as belonging to a communication group based at least in part on the received communication preferences and the received status identifiers.

Some alternative example machine-readable non-transitory medium may have stored therein instructions that, when executed, operatively enable a mobile device to receive a communication preference, provide the received communication preference and a status identifier to a communication server, and receive a request to join a first VOIP conference call from the communication server, wherein the request to join the first VOIP conference call is based at least in part on the provided communication preference and the provided status identifier.

The present disclosure additionally describes example systems for facilitating communication with cellular telephones. Example systems may include a communication module and a machine readable medium having stored therein instructions that, when executed by one or more processors, cause the communication module to receive a communication preference from a plurality of mobile devices, receive a status identifiers from the plurality of mobile devices, and designate one or more of the plurality of mobile devices as belonging to a communication group based at least in part on the received communication preferences and the received status identifiers.

Some alternative example systems may include a mobile device and a machine readable non-transitory medium having stored therein instructions that, when executed by one or more processors, operatively enable the mobile device to receive a communication preference, provide the received communication preference and a status identifier to a communication server, and receive a request to join a VOIP conference call from the communication serve, wherein the request to join the VOIP conference call is based at least in part on the provided communication preference and the provided status identifier.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure, and are therefore, not to be considered limiting of its scope. The disclosure will be described with additional specificity and detail through use of the accompanying drawings.

In the drawings:

FIG. 1 illustrates a block diagram of an example mobile device;

FIG. 2 illustrates a block diagram of an example system for providing channel-based communication using VOIP;

FIG. 3 illustrates a flow chart of an example method for facilitating channel-based like communication via VOIP;

FIG. 4 illustrates a flow chart of another example method for facilitating channel-based like communication via VOIP;

FIG. 5 illustrates an example computer program product;

FIG. 6 illustrates another example computer program product; and

FIG. 7 illustrates a block diagram of an example computing device, all arranged in accordance with at least some embodiments of the present disclosure.

### DETAILED DESCRIPTION

The following description sets forth various examples along with specific details to provide a thorough understanding of claimed subject matter. It will be understood by those skilled in the art that claimed subject matter might be practiced without some or more of the specific details disclosed herein. Further, in some circumstances, well-known methods, procedures, systems, components and/or circuits have not been described in detail, in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

This disclosure is drawn, inter alia, to methods, devices, systems and computer readable media related to facilitating a channel-based communication via VOIP.

Parties may communicate via unlicensed channel radio technology by broadcasting and receiving transmissions on a particular channel (e.g., broadcast frequency). In some instances, a particular channel may have a universal usage. For example, in the United States, channel 17 (e.g., 27.165 MHz) may be universally recognized as being used for communication regarding freeways running north and south, while channel 19 (e.g., 27.185 MHz) may be universally recognized as being used for communication regarding freeways running east and west.

As an example, someone traveling northbound on a freeway may broadcast (and receive) communications by tuning their unlicensed channel radio to channel 17. As channel 17 may be universally recognized as being reserved for communication regarding north and south bound freeways, any information communicated (e.g., road hazards, traffic, police presence, or the like) may be from other individuals also traveling nearby (e.g., on the same freeway, on a nearby north/south freeway, or the like). As an alternate example, outdoor enthusiasts may universally recognize channel 4 (e.g., 27.005 MHz) as being used for communication while in an outdoor recreation area. Accordingly, someone in an outdoor recreation area may use channel 4 to communicate with others individuals who may also be in the outdoor recreation area.

Although a particular channel may have a universally recognized usage undesirable communication may still be broadcast on a particular channel. For example if a party is unaware of the universal usage, they may use the channel for other types of communication. Additionally, enforcement of the universal usage may be difficult (e.g., transmitting parties are typically mobile, transmitting parties may be anonymous, or the like). Furthermore, as there are a limited number of broadcast frequencies, there may be some overlap in usage. For example, someone traveling north on one freeway may communicate with another party traveling north on a nearby freeway, by using channel 17. Although both parties are observing the universally recognized usage for channel 17, the information communicated may not be relevant to either party as they are traveling on different freeways.

Another shortcoming of unlicensed channel radio communication is that the transmission distance of unlicensed channel radio may be unpredictable (e.g., due to weather, physical obstructions, or the like).

Various embodiments of the present disclosure may provide a channel-based radio communication experience using VOIP. As used herein, channel-based like communication may refer to communication with others based on a particular classification. For example, channel-based like communication may refer to communicating (e.g., over VOIP) with other travelers on a particular freeway. As an alternate example, channel-based like communication may refer to communicating with others located within a geographic designation (e.g., a park, or the like). As another alternate example, channel-based like communication may refer to communicating with other travelers on a particular freeway, who are also located within a particular distance from each other. It is to be appreciated, that these scenarios are given only as examples, and are not intended to be limiting.

The following non-limiting examples are given to further illustrate what channel-based like communication may refer to as well as to illustrate various possible example implementations of the present disclosure.

In one example, a cloud service that may enable drivers (e.g., truck, taxi, recreational, or the like) to participate in channel-based communication with other drivers is described. In general, the cloud service may allow the drivers to communicate freely with a group of the other drivers that match specified criteria. The cloud service may include a communication server, which may enable the drivers to use their smart phones to communicate over VOIP in a channel-based manner as described.

The communication server may receive (e.g., via the Internet) a communication preference and a status identifier from each of the smart phones. In some embodiments, the status identifiers may include global positioning system (GPS) coordinates, a type of vehicle (e.g., semi-truck, RV, passenger van, or the like), personal information of a driver (e.g., age, gender, nationality, or the like), and/or information regarding a group in the vehicle (e.g., driver only, small children, elderly, or the like). In some embodiments, the drivers may use an application on their smart phones to specify some of the status identifiers (e.g., vehicle type, or the like). Each smart phone may then transmit a status identifier to the communication server.

In some embodiments, the communication preferences may include a location of interest (e.g., GPS coordinates, location on a map, freeway, national part, parking lot, camping ground, or the like) and/or a distance measurement. In some embodiments, each smart phone may have a transmitting communication preference and a receiving communication preference. In general, the transmitting communication preferences may specify conditions regarding outgoing communications (e.g., to other drivers) while the receiving communication preferences may specify conditions regarding incoming communications (e.g., from other drivers). For example, a transmitting communication preference for a first smart phone may be all drivers with a status identifier indicating that their vehicle is an RV, that they are located on freeway 90 and that they are also located within 10 miles of the location of the first smart phone (e.g., as specified by the first smart phones status identifier). As another example, a receiving communication preference for the first smart phone may be all drivers with a status identifier indicating that their location is within 5 miles of the first smart phones. In some embodiments, the drivers may use an application on their smart phones to specify the communication preference(s). Each smart phone may then transmit a communication preference(s) to the communication server.

The communication server may then process the status identifiers and communication preferences. Based on the processing, the communication server may form a communication group for each respective smart phone. The communication server may then assign smart phones to each communication group based on processing the communication preferences and status identifiers. The communication server may alter the composition of the communication groups (e.g., every minute, or the like) based on receiving updated status identifiers and communication preferences from the smart phones. For example, a first communication group corresponding to a first smart phone may include 120 other smart phones now, and once a received status identifier (e.g., indicating the smart phone has left a particular freeway, or the like) for the first smart phone is received and processed by the communication server, the first communication group may include 5 other smart phones.

In general, the communication server may process the status identifiers (or updated status identifiers) from each smart phone to determine if they satisfy the communication preferences for the other smart phones. In some examples, a smart phone may have more than one communication preference. For example, a road information preference and a socializing preference may be specified. Both preferences may be transmitted to the communication server and the driver may select (e.g., using an application on his smart phone) which preference to use for communication.

As another non-limiting example, the communication server may receive (e.g., via the Internet) a communication preference and a status identifier from each of the smart phones.

The communication server may then process the status identifiers and communication preferences. Based at least in part upon the processing, the communication server may assign each of the smart phones to one or more communication groups and establish a VOIP conference call for each communication group(s).

The smart phones may periodically (e.g., at set intervals, upon request from the communication server, by manual refresh by a user of the smart phone, or the like) send updated status identifiers to the communication server. For example, if a driver of a vehicle is carrying the first smart phone, the location of the smart phone will change with continued travel of the vehicle. Accordingly, an updated status identifier sent by the first smart phone can reflect this changed position. In response to the receipt of an updated status identifier, the communication server may process the updated status identifier and alter the composition of the communication groups accordingly.

In general, the communication server may process the status identifiers (or updated status identifiers) from each smart phone to determine if they satisfy the communication preferences for the other smart phones. For example, the communication server may process the status identifier of the first smart phone to determine if it satisfies the communication preference for the second smart phone. Similarly, the communication server may process the status identifier of the second smart phone to determine if it satisfies the communication preference of the first smart phone. Assuming that both communication preferences are satisfied, the communication server may designate both the first and the second smart phone as belonging in the same communication group. The communication server may also establish a VOIP conference call for the communication group and invite both smart phones to join the VOIP conference call. If the communication server determines that the status identifiers do not satisfy the communication preferences, then the first and the second smart phones may be placed in different communication groups.

As updated status identifiers are received from one or both of the smart phones, the communication server may process them and make modifications to the composition of the communication group accordingly. In addition, a smart phone may be dropped from a VOIP conference call if the smart phone is no longer included in the corresponding communication group. Furthermore, the communication server may bifurcate (i.e. split, or the like) a communication group and corresponding VOIP conference call based upon the processing of one or more updated status identifiers.

As a more specific example, assume that the received communication preferences for both the first and the second smart phones indicate that communication regarding freeway A is desired and that the status identifiers of each smart phone include Global Positioning System (GPS) coordinates for each respective smart phone. Further assume that after processing the status identifiers, the communication server determines that both smart phones are located on freeway A (e.g., based on cross referencing GPS coordinates with a map, or the like). Under these assumptions, the communication server may assign the first and second smart phones to the same communication group (e.g., a first communication group). The communication server may also establish a VOIP conference call for the first communication group and invite the first and second smart phones to join the VOIP conference call. Accordingly, users of the first and second smart phones may communicate with each other over the VOIP conference call.

As a further example, assume that the communication server received an updated status identifier from the first smart phone. Additionally assume that after processing the updated status identifier, the communication server determined that the first smart phone was no longer located on freeway A. As such, the updated status identifier does not satisfy the communication preference corresponding to the second smart phone. Accordingly, the communication server may remove the first smart phone from the first communication group. In addition to modifying the composition of the first communication group, the communication server may also drop the first smart phone from the VOIP conference call.

As indicated, the above examples are given for illustration only and are not intended to be limiting. It is to be appreciated, that the communication server may receive communication preferences and status identifiers from more than two smart phones. Additionally, the communication server may assign the smart phones to any number of communication groups. As a result, any number of VOIP conference calls may also be established.

Furthermore, the communication preferences may include any number of limitations. For example, the communication preferences for the first smart phone may indicate that communication from other smart phones located on freeway A and within 30 miles of the position of the first smart phone is desired. In addition to updated status identifiers, the smart phones may also update their communication preferences. As such, the communication server may process the updated communication preferences and make modifications to the composition of the communication groups accordingly. It is to be appreciated, that the communication preferences may change continuously. For example, as the vehicle corresponding to a smart phone is changing its location and the freeway it is currently located on, this may trigger a change in the communication preferences for that smart phone.

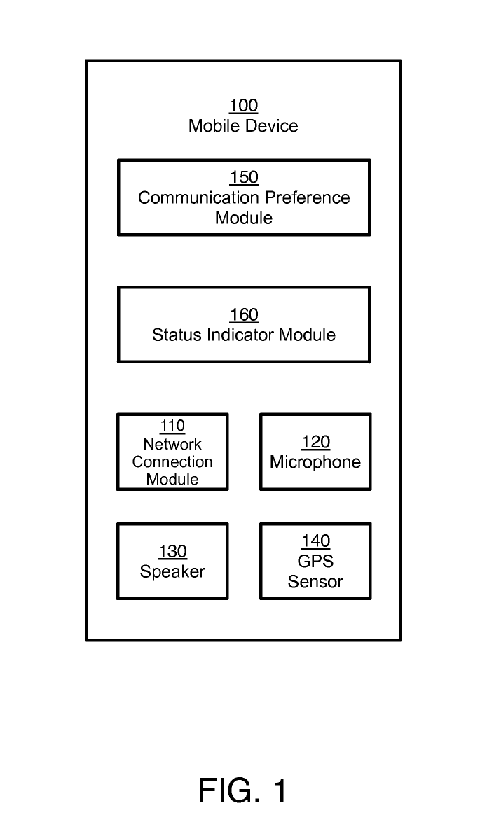

Furthermore, although the above example references smart phones, various embodiments of the present disclosure may be implemented using other Internet connectable devices besides smart phones (e.g., a tablet computer, or the like). Accordingly, portions of the description reference a “mobile device”. FIG. 1 illustrates a block diagram of an example mobile device 100, arranged in accordance with at least some embodiments of the present disclosure.

It is to be appreciated that, although the example referenced above uses smart phones, the mobile device 100 is not required to be a smart phone. In general, the mobile device 100 may be any Internet connectible device (e.g., smart phone, tablet computer, laptop computer, or the like) that includes (or allows connection to) a microphone and speaker. Furthermore, it is not required that the mobile device 100 be mobile. For example, in some examples, the mobile device 100 may be a desktop computer connected to the Internet via a wired LAN connection.

As depicted, the mobile device 100 may include a network connection module 110. In general, the network connection module 110 may facilitate connecting to the Internet (e.g., via a cellular data connection, via a Wi-Fi connection, via a wired LAN connection, or the like). Additionally, the mobile device 100 may include a microphone 120 and a speaker 130. In general, the microphone 120 may facilitate receipt of audible communication, while the speaker 130 may facilitate producing an audible communication. For example, a user of the mobile device 100 may use the microphone 120 and the speaker 130 to participate in channel-based communication via VOIP as described herein. The mobile device 100 may also include a GPS sensor 140 configured to determine a location of the mobile device 100 using GPS coordinates.

The mobile device 100 may also include a communication preference module 150 and a status identifier module 160. In general, the communication preference module 150 may be configured to receive communication preferences from a user of the mobile device 100 and also transmit the received communication preferences to a communication server. Similarly, the status identifier module 160 may be configured to determine a status (e.g., current GPS location, user specified location, or the like) and transmit the determined status to a communication server. Various further examples of communication preferences, status identifiers, and communication servers are provided herein.

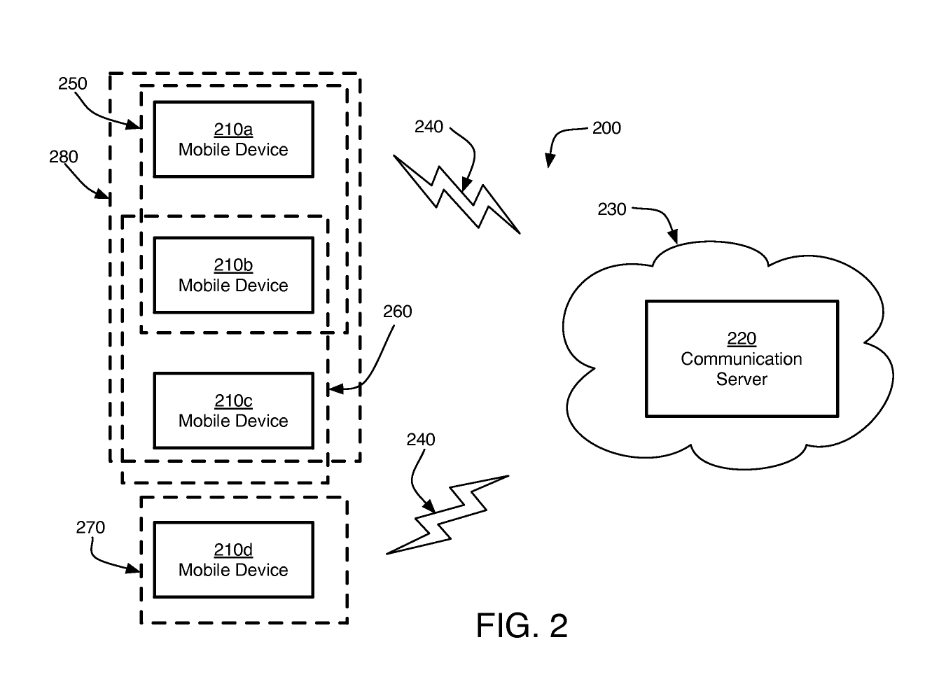

FIG. 2 illustrates a block diagram of an example system 200 for providing channel-based communication using VOIP, arranged in accordance with at least some embodiments of the present disclosure. As depicted, the system 200 may include mobile devices 210a-210d (collectively referred to herein as mobile devices 210). Although four mobiles devices are shown in FIG. 2 for purposes of clarity and ease of explanation, it is to be appreciated that the system 200 may include more or less mobile devices 210 than represented in FIG. 2. In some embodiments of the present disclosure, each of the mobile devices 210 may correspond to the mobile device 100 shown in FIG. 1. Accordingly, reference to some elements depicted in FIG. 1 may be made when describing FIG. 2. However, it is to be appreciated that these references are for convenience and clarity in describing some examples of the present disclosure and are not intended to be limiting.

The system 200 may also include a communication server 220, assessable via Internet 230. Each of the mobile devices 210 may connect to the Internet 230 via wireless connection 240 (e.g., cellular data connection, Wi-Fi hotspot, or the like). It is to be appreciated that although FIG. 2 depicts the mobile devices 210 connecting to the Internet 230 via the wireless connection 240, one or more of the mobile devices 210 may connect to the Internet 230 over a different connection than the wireless connection 240. For example, the mobile devices 210 may connect to the Internet 230 over separate wireless connections (e.g., individual cellular data connections, separate Wi-Fi networks, or the like). Furthermore, in some examples, the mobile devices 210 may connection to the Internet 230 over different types of wireless connections. As another example, one or more of the mobile devices 210 may connect to the Internet over a wired Internet connection (e.g., local LAN connection, or the like).

In general, the communication server 220 may be configured to receive a communication preference and a status identifier from each of the mobile devices 210. For example, the communication server 220 may receive a communication preference from the communication preference modules 150 of one or more mobile devices 210. Similarly, the communication server 220 may receive a status identifier from the status identifier modules 160 of one or more mobile devices 210. As described in the example detailed above, one or more of the mobile devices 210 may also transmit an updated status identifier (or updated communication preference) to the communication server 220.

The communication server 220 may be configured to process the received communication preferences and status identifiers (or updated communication preferences and/or status identifiers) and assign the mobile devices 210 to communication group(s) based at least in part upon the processing. Furthermore, the communication server 220 may be configured to establish VOIP conference call(s) for the communication group(s) and invite the mobile devices 210 to join the VOIP conference call(s) associated with their respective communication group(s). In some embodiments, as indicated above, a communication group may be generated for each of the mobile device 210 (e.g., based on the corresponding communication preferences and/or status identifiers). Additionally, in some embodiments, a user of the mobile devices 210 may initiate joining the VOIP conference call (e.g., from an application on each respective mobile device 210, or the like)

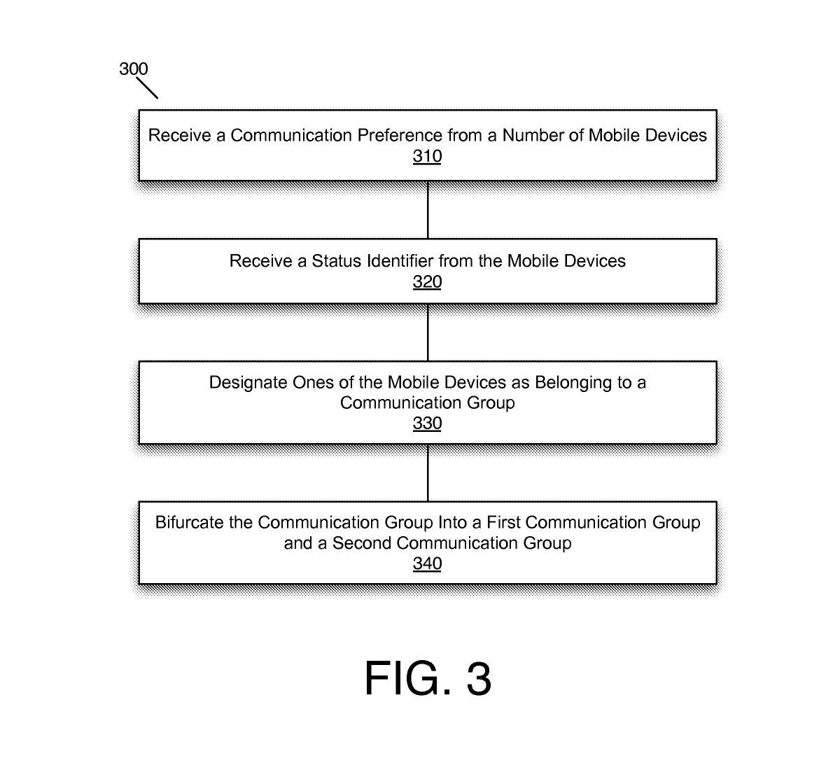

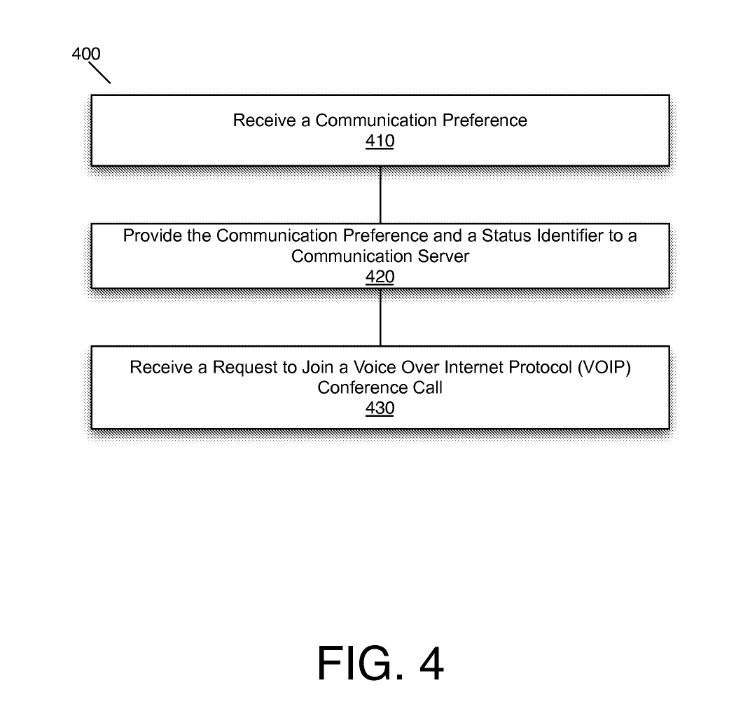

FIG. 2 also depicts example communication groups 250-280. It is to be appreciated, that the grouping of mobile devices 210 shown in FIG. 2 is hypothetical. However, the groupings are chosen to highlight a few example groupings and implementations that may be embodied by various examples of the present disclosure. The communication groups 250-280 will be further described and referenced in conjunction with FIGS. 3 and 4. The communication groups 250-280 as depicted in FIG. 2 are: a first communication group 250 including the mobile devices 210a and 210b (e.g., which may be assigned to the mobile device 210a); a second communication group 260, which includes the mobile devices 210b and 210c (e.g., which may be assigned to the mobile device 210b); a third communication group 270, which includes the mobile device 210d (e.g., which may be assigned to the mobile device 210c); and a fourth communication group 280, which includes the first communication group 250 and the second communication group 260 (e.g., which may be assigned to the mobile device 210d).

FIGS. 3 and 4 illustrates flow charts of example methods 300 and 400, respectively, for facilitating channel-based communication via VOIP, arranged in accordance with at least some embodiments of the present disclosure. In some portions of the description, illustrative implementation of the methods 300 and 400 are described with reference to elements of the mobile device 100 and the system 200 depicted in FIGS. 1 and 2. However, the described embodiments are not limited to these depictions. More specifically, some elements depicted in FIGS. 1 and 2 may be omitted from example implementations of the methods detailed herein. Furthermore, other elements not depicted in FIGS. 1 and 2 may be used to implement example methods.

Additionally, FIGS. 3 and 4 employ block diagrams to illustrate the example methods detailed therein. These block diagrams may set out various functional blocks or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in the figures may be eliminated. In some examples, the actions shown in one figure may be operated using techniques discussed with respect to another figure. Additionally, in some examples, the actions shown in these figures may be operated using parallel processing techniques. The above described, and others not described, rearrangements, substitutions, changes, modifications, etc., may be made without departing from the scope of claimed subject matter.

Turning now to the method 300 and FIG. 3. In general, the method 300 depicts an example method that may be implemented by the communication server 220 to interact with the mobile devices 210 and provide a channel-based VOIP communication experience. Beginning at block 310, “Receive a Communication Preference from a Number of Mobile Devices”, the communication server 220 may include logic and/or features configured to receive a communication preference from one or more of the mobile devices 210. In general, at block 310, the communication server 220 may receive a communication preference from one or more of the mobile devices 210. In some examples, the mobile devices 210 may each include a communication preference module 150. As such, at block 310, the communication server 220 may receive a communication preference from the communication preference module 150 of each respective mobile device 210.

In some examples, the communication server 220 may receive a communication preference from each of the mobile devices 210. With some examples (e.g., if one of the mobile devices 210 is transmitting an updated communication preference, if one of the mobile devices 210 is temporarily disconnected from the Internet, or the like), the communication server 220 may receive a communication preference from less than all of the mobile devices 210.

In some embodiments of the present disclosure, a communication preference may indicate a particular area of interest (e.g., a freeway of travel, a geographic location, a town, a city, or the like). In some examples, a communication preference may indicate a particular channel of interest from a listing of universally recognized channels (e.g., similar to traditional CB radio, or the like).

In some embodiments, a communication preference may include an indication of a geographic are of interest. For example, a communication preference may specify that communication originating from within a specified distance (e.g., of the mobile devices 210's current location, of a geographic landmark, or the like) is desired. In some embodiments the communication preference may include a description of the type of vehicle a wants to communicate with (e.g., semi-truck, RV, passenger vehicle, or the like). In some embodiments, the communication preference may include a description of the type of person a user wants to communicate with (e.g., families with small children, skiers, or the like). Additionally, as stated above, in some embodiments, the communication preferences may include a transmitting preference and a receiving preference.

Continuing from block 310 to block 320, “Receive a Status Identifier from the Mobile Devices”, the communication server 220 may include logic and/or features configured to receive a status identifier from one or more of the mobile devices 210. In general, at block 320, the communication server 220 may receive a status identifier from one or more of the mobile devices 210. In some examples, the mobile devices 210 may each include a status identifier module 160. As such, at block 320, the communication server 220 may receive a status identifier from the status identifier modules 160 of each respective mobile device 210.

In some examples, the communication server 220 may receive a status identifier from each of the mobile devices 210. With some examples (e.g., if one of the mobile devices 210 is transmitting an updated communication preference, if one of the mobile devices 210 is temporarily disconnected from the Internet, or the like), the communication server 220 may receive a status identifier from less than all of the mobile devices 210.

In some embodiments of the present disclosure, a status identifier may indicate the current location of the mobile device 210. For example, a status identifier may be a GPS coordinate. Alternatively, a status identifier may be a geographic landmark (e.g., a national park, an exit on a particular freeway, a cross street on a particular road, or the like). In some embodiments, a status identifier may include the type of vehicle in which the mobile device is carried. In some embodiments, a status identifier may include the type of people in the vehicle corresponding to the mobile device.

Continuing from block 320 to block 330, “Designate Ones of the Mobile Devices as Belonging to a Communication Group”, the communication server 220 may include logic and/or features configured to designate one or more of the mobile devices 210 as belonging to a communication group. In general, at block 330, the communication server 220 may assign the mobile devices 210 to communication group(s) based at least in part upon the communication preferences received at block 310 and the status identifiers received at block 320, as indicated above

As described in the example above, the communications server 220 may be configured to process the status identifiers and the communication preferences and designate, based at least in part upon the processing, each of the smart phones 210 as belonging to one or more communication group(s).

For example, assume that at block 310, the communication server 220 received communication preferences from the mobile devices 210a, 210b, and 210c indicate that these mobile devices 210 desire communication regarding freeway A. Further, assume that a communication preference received from the mobile device 210d indicate that communication regarding freeway B was desired by the mobile device 210d. Further assume that all received communication preferences indicated that only communication originating from within 15 miles of the respective mobile device 210 was desired. More specifically, under these assumptions, the communication preference for the smart phone 210a indicates that communication regarding freeway A and originating from within 15 miles of the location of the smart phone 210a is desired. Additionally, assume that at block 320, the communication server 220 received status identifiers including GPS coordinates from each of the respective smart phones 210.

At block 330, the communication server may process the status identifiers and the communication preferences and designate the smart phones 210 as belonging to one or more communication group(s). Assume, that at block 330 the communication server 220 determines that the mobile devices 210a and 210b were located on freeway A, 10 miles apart from each other. For example, by cross-referencing the GPS coordinates of the smart phones 210a and 210b on a map. Additionally, assume that at block 330 the communication server 220 determined that the mobile device 210c was also located on freeway A, 10 miles apart from the mobile device 210b and 18 miles apart from the mobile device 210a. Additionally still, assume that at block 330 the communication server 220 determined that the mobile device 210d was located on freeway B. Using these assumptions, at block 330, the communication server 220 may: assign the mobile devices 210a and 210b to the first communication group 250; assign the mobile devices 210b and 210c to the second communication group 260; and assign the mobile device 210d to the third communication group 270.

As an alternate example, if a specific mobile device belonging to a truck driver has asked to communicate with phones 10 miles away on his freeway, than the communication group assigned to the truck drivers mobile device may include all other mobile devise matching this criteria. Furthermore, the truck drivers mobile device may also need to match the criteria of the other mobile devices. For example, if another driver wished to communicate only within 5 mile distance his mobile device may not be included in the communication group for the truck drivers mobile device. Alternatively, if a communication preference indicated that communicate with truck drivers was not desired, the corresponding mobile device may also not be included in the truck drivers communication group.

As indicated in the example presented above, the mobile devices 210 may be configured to periodically transmit updated status identifiers and/or communication preferences to the communication server 220. Accordingly, actions associated with one or more of the blocks 310, 320, and/or 330 may be repeated. For example, the communication server 220 may receive a communication preference and a status identifier from each of the mobile devices 210 at blocks 310 and 320. The communication server may then designation the mobile devices 210 as belonging to one or more communication groups(s) at block 330. Subsequently, block 320 and 330 may be repeated. That is, the communication server 220 may receive an updated status identifier from one or more mobile devices 210 as block 320 is repeated. Then, the communication server 220 may process the updated status identifier and adjust the composition of the communication group(s) accordingly as block 330 is repeated.

Continuing from block 330 to block 340, “Bifurcate the Communication Group Into a First Communication Group and a Second Communication Group”, the communication server 220 may include logic and/or features configured to bifurcate a communication group into two or more communication groups. In general, at block 340, the communication server 220 may split one communication group into two or more communication groups. As part of the bifurcation, the communication server 220 may re-designate the mobile devices 210 that were designated as belonging to the bifurcated communication group as belonging to one or more of the communication groups that result from the bifurcation.

For example, assume that based upon the communication preferences received at block 310 and the status identifiers received at block 320, the communication server 220 designated (e.g., at block 330) the mobile devices 210a, 210b, and 210c as belonging to the communication group 280. Further assume, that the communication server 220 received (e.g., at a subsequent occurrence of the block 320) an updated status identifier for the mobile device 210c. Further still, assume that the communication server processed the updates status identifier for the mobile device 210c (e.g., at a subsequent iteration of the block 330) and determined that the updated status identifier no longer satisfied the communication preferences for the mobile device 210a. Under these assumptions, at block 340, the communication server 220 may bifurcate the communication group 280 into the communication group 250 and the communication group 260. More specifically, the communication group 280 may be split into the communication groups 250 and 260 to account for the updated status identifier for the mobile device 210c not satisfying the communication preference for the mobile device 210a.

In some examples, at block 340, the communication server 220 may bifurcate a communication group (e.g., the communication group 280) into two communication groups (e.g., the communication groups 250 and 260,) by establishing two new communication groups and re-designating the mobile devices 210 belonging to the original communication group as belonging to one or both of the new communication groups. With alternative examples, the communication server 220 may establish a single new communication group and re-designate one or more of the mobile devices belonging to the original communication group as belonging to the new communication group.

As a further example, a communication group may be bifurcated into more than two communication groups. For example, a communication group may be bifurcated into three (or more) communication groups at block 340. Additionally, one or more of the mobile device 210 may be designated as belonging to more than one communication group. For example, as depicted in FIG. 2, the mobile device 210b belongs to both the communication group 250 and the communication group 260.

With some embodiments of the present disclosure, at block 330, the communication server 220 may include logic and/or features configured to establish a VOIP conference call for the communication groups (e.g., using a third-party VOIP service, using a proprietary VOIP service, or the like). For example, a first VOIP conference call may be established for the first communication group 250, etc. Additionally, at block 330, the communication server 220 may include logic and/or features configured to invite the mobile devices 210 to join the VOIP conference call corresponding to the respective communication groups. For example, the mobile devices 210a and 210b may be invited to join the VOIP conference call corresponding to the first communication group 250, etc.

Similarly, at block 330, VOIP conference calls corresponding to the communication groupings may be updated. For example, a new VOIP conference call may be established if needed. Alternatively and/or additionally, a VOIP conference call may be ended. Additionally, a mobile device 210 may be dropped from a VOIP conference call based upon the updated designation of communication groups. For example, if the mobile device 210 is no longer included within a particular communication group, the mobile device may be dropped from the corresponding VOIP conference call. Similarly, a mobile device 210 may be invited to join an alternate and/or additional VOIP conference call based upon the updated communication groups.

In some embodiments, at bock 340, the communication server 220 may include logic and/or features configured to bifurcate a VOIP conference call. For example, the communication sever 220 may bifurcate a VOIP conference call corresponding to the communication group 280 into two conference calls to correspond to the communication groups 250 and 260 respectively. In some examples, a VOIP conference call may be bifurcated by establishing an additional VOIP conference call, inviting one or more of the mobile devices 210 participating in the original VOIP conference call to join the additional VOIP conference call and/or dropping one or more of the mobile devices 210 participating in the original VOIP conference call from the original VOIP conference call.

Turning now to the method 400 and FIG. 4. In general, the method 400 depicts an example method that may be implemented by one or more of the mobile devices 210 to interact with the communication server 220 and provide a channel-based VOIP communication experience. Beginning at block 410, “Receive a Communication Preference”, the mobile device 100 may include logic and/or features configured to receive a communication preference. In general, at block 410, the communication preference module 150 may receive a communication preference. In some embodiments, the communication preference module 150 may receive the communication preference from a user of the mobile device 100. For example, the user may specify a communication preference (e.g., using a keyboard, a touchscreen, a voice command, or the like).

In some embodiments, the communication preference module 150 may determine a communication preference based at least in part upon a pre-specified setting. For example, suppose that communication regarding whichever freeway a user is traveling on is desired. The communication preference module 150 may determine (e.g., periodically, at set intervals, as a forced update, or the like) GPS coordinates for the current location of the mobile device 100 (e.g., using the GPS sensor 140). The communication preference module 150 may then determine the freeway the user of the mobile device is currently traveling on by cross-referencing the determined GPS coordinates with a map. This determined freeway may then be used to set the communication preference.

Continuing from block 410 to block 420, “Provide the Communication Preference and a Status Identifier to a Communication Server”, the mobile device 100 may include logic and/or features configured to provide the received communication preference and a status identifier to the communication server 220. In general, at block 420, the communication preference module 150 and the status identifier module 160 may transmit (e.g., over the Internet, or the like) the communication preference received at block 410 and a status identifier to the communication server 220. As indicated in the examples above, the mobile device 110 may periodically (e.g., at fixed intervals, upon request from the communication server, upon manual refresh by a user, or the like) transmit status identifiers and/or communication preferences to the communication server 220. Accordingly, block 420 may be repeatedly performed.

Continuing from block 420 to block 430, “Receive a Request to Join a Voice Over Internet Protocol (VOIP) Conference Call”, the mobile device 100 may include logic and/or features configured to receive a request to join a VOIP conference call. In general, at block 430, the mobile device 100 may receive a request to join a VOIP conference call from the communication server 220. For example, the mobile device 100 may join the VOIP conference call using an application configured to facilitate VOIP communication.

In some embodiments of the present disclosure, the mobile device 100 may be configured to automatically accept the request. More specifically, the mobile device 100 may be configured to accept the request without input from a user of the mobile device 100. With some embodiments, the mobile device 210 may be configured to ask (e.g., via a pop-up on screen, via voice prompt, or the like) a user of the mobile device 100 whether or not to accept the request to join the VOIP conference call.

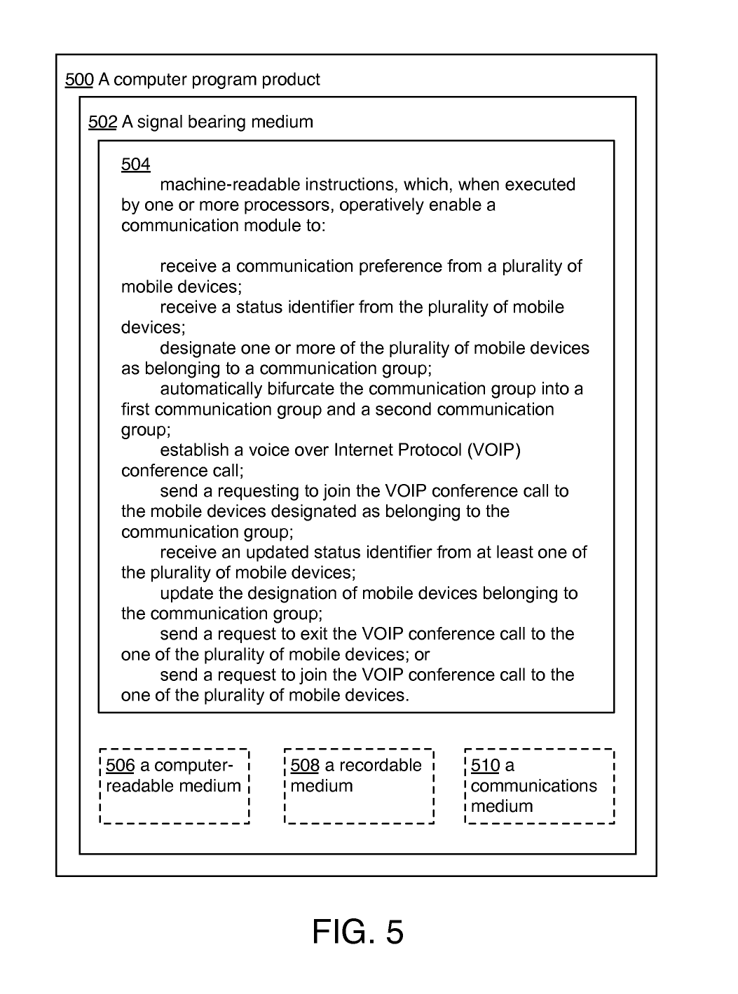

In general, the method described with respect to FIG. 3 and elsewhere herein may be implemented as a computer program product, executable on any suitable computing system, or the like. For example, a computer program product for facilitating channel-based communication via VOIP may be provided. Example computer program products are described with respect to FIG. 5 and elsewhere herein.

FIG. 5 illustrates an example computer program product 500, arranged in accordance with at least some embodiments of the present disclosure. The computer program product 500 may include machine-readable non-transitory medium having stored therein instructions that, when executed, operatively enable a communication server to facilitate channel-based communication via VOIP according to the processes and methods discussed herein. The computer program product 500 may include a signal bearing medium 502. The signal bearing medium 502 may include one or more machine-readable instructions 504, which, when executed by one or more processors, may operatively enable a computing device to provide the functionality described herein. In various examples, the devices discussed herein may use some or all of the machine-readable instructions.

In some examples, the machine-readable instructions 504 may include receive a communication preference from a number of mobile devices. In some examples, the machine-readable instructions 504 may include receive a status identifier from the mobile devices. In some examples, the machine-readable instructions 504 may include designate one or more of the mobile devices as belonging to a communication group based at least in part on the received communication preferences and the received status identifiers. In some examples, the machine-readable instructions 504 may include automatically bifurcate the communication group into a first communication group and a second communication group. In some examples, the machine-readable instructions 504 may include establish a (VOIP) conference call. In some examples, the machine-readable instructions 504 may include send a requesting to join the VOIP conference call to the mobile devices designated as belonging to the communication group. In some examples, the machine-readable instructions 504 may include receive an updated status identifier from at least one of the mobile devices. In some examples, the machine-readable instructions 504 may include update the designation of mobile devices belonging to the communication group based at least in part on the updated status identifiers. In some examples, the machine-readable instructions 504 may include send a request to exit the VOIP conference call to the one of the mobile devices. In some examples, the machine-readable instructions 504 may include send a request to join the VOIP conference call to the one of the mobile devices.

In some implementations, signal bearing medium 502 may encompass a computer-readable medium 506, such as, but not limited to, a hard disk drive, a Compact Disc (CD), a Digital Versatile Disk (DVD), a digital tape, memory, etc. In some implementations, the signal bearing medium 502 may encompass a recordable medium 508, such as, but not limited to, memory, read/write (R/W) CDs, R/W DVDs, etc. In some implementations, the signal bearing medium 502 may encompass a communications medium 510, such as, but not limited to, a digital and/or an analog communication medium (e.g., a fiber optic cable, a waveguide, a wired communication link, a wireless communication link, etc.). In some examples, the signal bearing medium 502 may encompass a machine readable non-transitory medium.

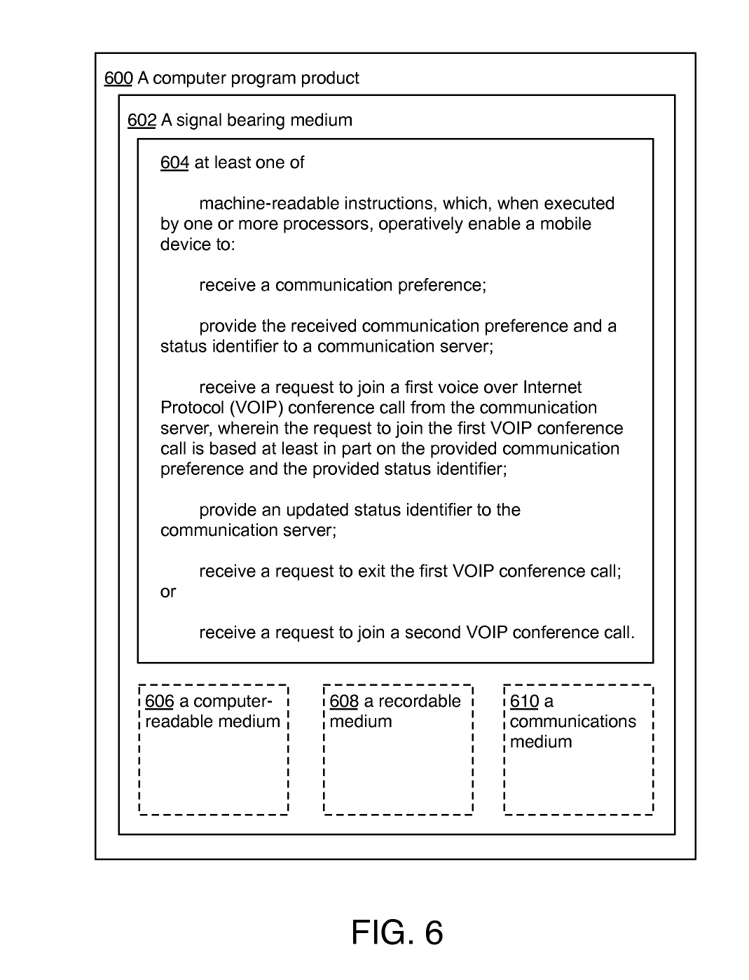

In general, the method described with respect to FIG. 4 and elsewhere herein may be implemented as a computer program product, executable on any suitable computing system, or the like. For example, a computer program product for facilitating channel-based communication via VOIP may be provided. Example computer program products are described with respect to FIG. 6 and elsewhere herein.

FIG. 6 illustrates an example computer program product 600, arranged in accordance with at least some embodiments of the present disclosure. The computer program product 600 may include machine-readable non-transitory medium having stored therein instructions that, when executed, operatively enable a mobile device to facilitate channel-based communication via VOIP according to the processes and methods discussed herein. The computer program product 600 may include a signal bearing medium 602. The signal bearing medium 602 may include one or more machine-readable instructions 604, which, when executed by one or more processors, may operatively enable a computing device to provide the functionality described herein. In various examples, the devices discussed herein may use some or all of the machine-readable instructions.

In some examples, the machine-readable instructions 604 may include receive a communication preference. In some examples, the machine-readable instructions 604 may include provide the received communication preference and a status identifier to a communication server. In some examples, the machine-readable instructions 604 may include receive a request to join a first voice over Internet Protocol (VOIP) conference call from the communication server, wherein the request to join the first VOIP conference call is based at least in part on the provided communication preference and the provided status identifier. In some examples, the machine-readable instructions 604 may include provide an updated status identifier to the communication server. In some examples, the machine-readable instructions 604 may include receive a request to exit the first VOIP conference call. In some examples, the machine-readable instructions 604 may include receive a request to join a second VOIP conference call.

In some implementations, signal bearing medium 602 may encompass a computer-readable medium 606, such as, but not limited to, a hard disk drive, a Compact Disc (CD), a Digital Versatile Disk (DVD), a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (e.g., a fiber optic cable, a waveguide, a wired communication link, a wireless communication link, etc.). In some examples, the signal bearing medium 602 may encompass a machine readable non-transitory medium.

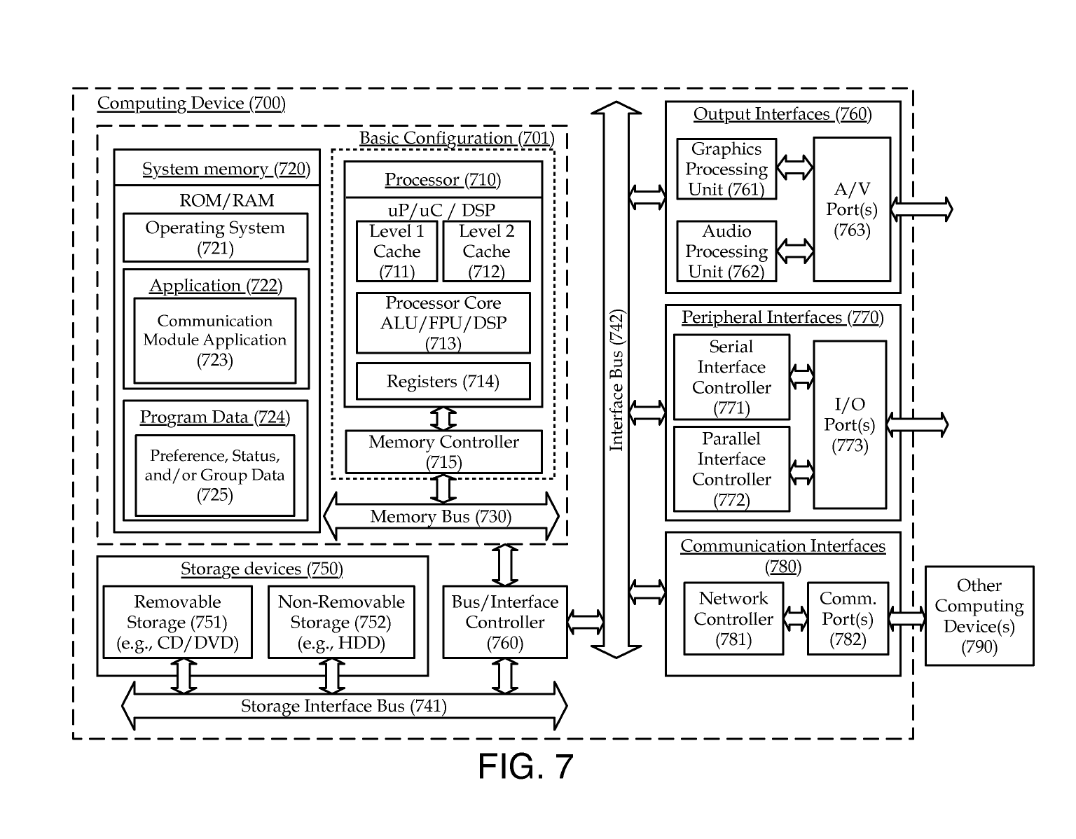

In general, the method described with respect to FIGS. 3 and 4, and elsewhere herein may be implemented in any suitable server and/or computing system. Example systems may be described with respect to FIG. 7 and elsewhere herein. In general, the computer system may be configured to facilitate channel-based communication via VOIP.

FIG. 7 is a block diagram illustrating an example computing device 700, arranged in accordance with at least some embodiments of the present disclosure. In various examples, the computing device 700 may be configured to facilitate channel-based communication via VOIP as discussed herein. In one example of a basic configuration 701, the computing device 700 may include one or more processors 710 and a system memory 720. A memory bus 730 can be used for communicating between the one or more processors 710 and the system memory 720.

Depending on the desired configuration, the one or more processors 710 may be of any type including but not limited to a microprocessor (μP), a microcontroller (μC), a digital signal processor (DSP), or any combination thereof. The one or more processors 710 may include one or more levels of caching, such as a level one cache 711 and a level two cache 712, a processor core 713, and registers 714. The processor core 713 can include an arithmetic logic unit (ALU), a floating point unit (FPU), a digital signal processing core (DSP Core), or any combination thereof. A memory controller 715 can also be used with the one or more processors 710, or in some implementations the memory controller 715 can be an internal part of the processor 710.

Depending on the desired configuration, the system memory 720 may be of any type including but not limited to volatile memory (such as RAM), non-volatile memory (such as ROM, flash memory, etc.) or any combination thereof. The system memory 720 may include an operating system 721, one or more applications 722, and program data 724. The one or more applications 722 may include a communication module application 723 that can be arranged to perform the functions, actions, and/or operations as described herein including the functional blocks, actions, and/or operations described herein. The program data 724 may include preference, status, and/or group data 725 for use with the communication module application 723. In some example embodiments, the one or more applications 722 may be arranged to operate with the program data 724 on the operating system 721. This described basic configuration 701 is illustrated in FIG. 7 by those components within dashed line.

The computing device 700 may have additional features or functionality, and additional interfaces to facilitate communications between the basic configuration 701 and any required devices and interfaces. For example, a bus/interface controller 740 may be used to facilitate communications between the basic configuration 701 and one or more data storage devices 750 via a storage interface bus 741. The one or more data storage devices 750 may be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 720, the removable storage 751 and the non-removable storage 752 are all examples of computer storage media. The computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 742 for facilitating communication from various interface devices (e.g., output interfaces, peripheral interfaces, and communication interfaces) to the basic configuration 701 via the bus/interface controller 740. Example output interfaces 760 may include a graphics processing unit 761 and an audio processing unit 762, which may be configured to communicate to various external devices such as a display or speakers via one or more NV ports 763. Example peripheral interfaces 770 may include a serial interface controller 771 or a parallel interface controller 772, which may be configured to communicate with external devices such as input devices (e.g., keyboard, mouse, pen, voice input device, touch input device, etc.) or other peripheral devices (e.g., printer, scanner, etc.) via one or more I/O ports 773. An example communication interface 780 includes a network controller 781, which may be arranged to facilitate communications with one or more other computing devices 783 over a network communication via one or more communication ports 782. A communication connection is one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

The computing device 700 may be implemented as a portion of a small-form factor portable (or mobile) electronic device such as a cell phone, a mobile phone, a tablet device, a laptop computer, a personal data assistant (PDA), a personal media player device, a wireless web-watch device, a personal headset device, an application specific device, or a hybrid device that includes any of the above functions. The computing device 700 may also be implemented as a personal computer including both laptop computer and non-laptop computer configurations. In addition, the computing device 700 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to subject matter containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

1. A method to facilitate communication between a plurality of mobile devices, the method comprising:
receiving a communication preference from each of the plurality of mobile devices;
receiving a status identifier from the each of the plurality of mobile devices; and
designating one or more of the plurality of mobile devices as belonging to a communication group based at least in part on the received communication preferences and the received status identifiers.

2. The method of claim 1, further comprising:
establishing a voice over Internet Protocol (VOIP) conference call; and
sending a request to join the VOIP conference call to the mobile devices designated as belonging to the communication group.

3. The method of claim 1, further comprising:
receiving an updated status identifier from at least one of the plurality of mobile devices; and
updating the designation of mobile devices belonging to the communication group based at least in part on the received updated status identifier.

4. The method of claim 3, wherein the updating the designation of mobile devices belonging to the communication group causes one of the plurality of mobile devices to no longer be designated as belonging to the communication group, the method further comprising sending a request to exit the VOIP conference call to the one of the plurality of mobile devices.

5. The method of claim 3, wherein the updating the designation of mobile devices belonging to the communication group causes one of the plurality of mobile devices to be newly designated as belonging to the first communication group, the method further comprising sending a request to join the VOIP conference call to the one of the plurality of mobile devices.

6. The method of claim 1, wherein the communication preference includes at least one of a communication class or a communication distance.

7. (canceled)

8. The method of claim 1, wherein the status identifier includes a Global Positioning System (GPS) coordinate.

9. The method of claim 1, further comprising:
automatically bifurcating the communication group into a first communication group and a second communication group based at least in part on the received communication preferences and the received status identifiers.

10. The method of claim 9, further comprising:
receiving an updated status identifier from at least one of the plurality of mobile devices, wherein the automatically bifurcating the communication group into a first communication group and second communication group is based at least in part on the received updated status identifier.

11. The method of claim 10, wherein the automatically bifurcating the communication group into a first communication group and a second communication group comprises:
designating at least one of the plurality mobile devices as belonging to the first communication group based at least in part on the received status identifiers and the received updated status identifier;
designating at least one of the plurality mobile devices as belonging to the second communication group based at least in part on the received status identifiers and the received updated status identifier; and
designating at least one of the plurality of mobile devices as belonging to both the first communication group and the second communication group based at least in part on the received status identifiers and the received updated status identifier.

12. The method of claim 9, further comprising:
establishing a voice over Internet Protocol (VOIP) conference call for the ones of the plurality of mobile devices designated as belong to the communication group; and
bifurcating the VOIP conference call into a first VOIP conference call for the ones of the plurality of mobile devices designated as belonging to the first communication group and a second VOIP conference call for the ones of the plurality of mobile devices designated as belonging to the second communication group.

13. A method to facilitate communication between a plurality of mobile devices, the method comprising:
at a mobile device, receiving a communication preference;
providing, by the mobile device, the received communication preference and a status identifier to a communication server; and
receiving, by the mobile device, a request to join a first voice over Internet Protocol (VOIP) conference call from the communication server, wherein the request to join the first VOIP conference call is based at least in part on the provided communication preference and the provided status identifier.

14. The method of claim 13, further comprising:
providing an updated status identifier to the communication server;
receiving a request to exit the first VOIP conference call; and
receiving a request to join a second VOIP conference call.

15. The method of claim 13, wherein the communication preference includes at least one of a communication class or a communication distance.

16. (canceled)

17. The method of claim 13, wherein the status identifier includes a Global Positioning System (GPS) coordinate.

18-30. (canceled)

31. A system comprising:
a communication module; and
a machine readable non-transitory medium having stored therein instructions that, when executed by one or more processors, cause the communication module to:
receive a communication preference from each of a plurality of mobile devices,
receive a status identifiers from the each of the plurality of mobile devices, and
designate one or more of the plurality of mobile devices as belonging to a communication group based at least in part on the received communication preferences and the received status identifiers.

32. The system of claim 31, wherein the stored instructions that, when executed by one or more processors, further operatively enable the communication module to:
establish a voice over Internet Protocol (VOIP) conference call; and
send a requesting to join the VOIP conference call to the mobile devices designated as belonging to the communication group.

33. The system of claim 31, wherein the stored instructions that, when executed by one or more processors, further operatively enable the communication module to:
receive an updated status identifiers from at least one of the plurality of mobile devices; and
update the designation of mobile devices belonging to the communication group based at least in part on the updated status identifiers.

34. The system of claim 33, wherein the updating the designation of mobile devices belonging to the communication group causes one of the plurality of mobile devices to no longer be designated as belonging to the communication group, the stored instructions that, when executed by one or more processors, further operatively enable the communication module to send a request to exit the VOIP conference call to the one of the plurality of mobile devices.

35. The system of claim 33 wherein the updating the designation of mobile devices belonging to the first communication group causes one of the plurality of mobile devices to newly be designated as belonging to the communication group, the stored instructions that, when executed by one or more processors, further operatively enable the communication module to send a request to join the VOIP conference call to the one of the plurality of mobile devices.

36. The system of claim 31, wherein the communication preference includes at least one of a communication class or a communication distance.

37. (canceled)

38. The system of claim 31, wherein the status identifier includes a Global Positioning System (GPS) coordinate.

39. A system comprising:
a mobile device; and
a machine readable non-transitory medium having stored therein instructions that, when executed by one or more processors, operatively enable the mobile device to:
receive a communication preference;
provide the received communication preference and a status identifier to a communication server; and
receive a request to join a voice over Internet Protocol (VOIP) conference call from the communication serve, wherein the request to join the VOIP conference call is based at least in part on the provided communication preference and the provided status identifier.

40. The system of claim 39, wherein the stored instructions that, when executed by one or more processors, further operatively enable the mobile device to:
provide an updated status identifier to the communication server;
receive a request to exit the first VOIP conference call; and
receive a request to join a second VOIP conference call.

41. The system of claim 40, wherein the communication preference includes at least one of a communication class or a communication distance.

42. (canceled)

43. The system of claim 40, wherein the status identifier includes a Global Positioning System (GPS) coordinate.
